(19) United States
(12) Patent Application Publication
(10) Pub. No.: US 2008/0127630 A1
(43) Pub. Date: Jun. 5, 2008

(54) TURBINE FOR APPLICATION TO PULSE DETONATION COMBUSTION SYSTEM AND ENGINE CONTAINING THE TURBINE

(75) Inventors: Christian Lee Vandervort, Voorheesville, NY (US); Adam Rasheed, Glenville, NY (US); Anthony John Dean, Scotia, NY (US); Pierre Francois Pinard, Delmar, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/566,068

(22) Filed: Dec. 1, 2006

(51) Int. Cl. F02K 3/00

(52) U.S. Cl. 60/247; 60/226.1

(57) ABSTRACT

An engine contains at least one pulse detonation combustor which is positioned upstream of a turbine section, a stage of which is a Curtiss type turbine stage. Following the initial Curtiss type turbine stage, is either of a Rateau type turbine stage or a high efficiency turbine stage, or a combination thereof.

### BACKGROUND OF THE INVENTION

This invention relates to pulse detonation systems, and more particularly, to a turbine for application to pulse detonation combustion systems and an engine containing the turbine.

With the recent development of pulse detonation combustors (PDCs) and engines (PDEs), various efforts have been underway to use PDC/Es in practical applications, such as combustors for aircraft engines and/or as means to generate additional thrust/propulsion in a post-turbine stage. These efforts have been primarily directed to the operation of the pulse detonation combustor, and not to other aspects of the device or engine employing the pulse detonation combustor.

In typical gas turbine engines, the combustion stage is followed by a one or more turbine stage(s), which converts the heat energy generated by the combustion stage to mechanical energy to generate the work desired. This structure for gas turbine engines is well known and is used in many applications including power generation and aircraft engine applications. As indicated previously, developments have been made regarding the operation of pulse detonation combustors. However, little development has been made with regard to incorporating a pulse detonation combustor in a gas turbine engine. Namely, little development has been made with regard to the extraction of energy from a pulse detonation combustor.

Typical operation of a pulse detonation combustor generates very high speed, high pressure pulsed flow, as a result of the detonation process, These peaks are followed by periods of significantly lower speed and lower pressure flow. Because the operation of pulse detonation combustors and the detonation process is known, it will not be discussed in detail herein. When a pulse detonation combustor is used in the combustion stage of a gas turbine engine, the pulsed, highly transient flow is directed into the turbine stage(s). However, existing turbine stages have been designed to receive flow from a normal steady pressure combustion stage and not a pulse detonation combustor. As such, the efficiency of using typical turbine stages (mainly those typical in aircraft engines or land based gas turbines) are reduced when combined with a pulse detonation combustor.

Therefore, there exists a need to effectively and efficiently extract energy, in the turbine stage(s) of an engine, from a pulse detonation combustor in the combustion stage of an engine.

### SUMMARY OF THE INVENTION

In an embodiment of the present invention, an engine contains a combustor stage, containing at least one pulse detonation combustion device and a turbine stage or set of stages, where the turbine stage has a stage which is a Curtiss type turbine stage. In an embodiment of the invention, the Curtiss type turbine stage is the first turbine stage and is immediately downstream of an exit portion of pulse detonation combustor.

In a further embodiment, the turbine stage comprises a second stage downstream of the first stage, where the second stage is either Rateau type turbine stage or a high efficiency type turbine stage. The high efficiency type turbine stage is either an impulse type turbine or a reaction type turbine stage, or a combination of both.

In an additional embodiment of the present invention, the turbine stage contains a Rateau type turbine stage immediately downstream of the first stage (i.e. the Curtiss type turbine stage) and a high efficiency type turbine stage or stages immediately downstream of the Rateau type turbine stage.

By employing a Curtiss type turbine stage as a first stage of the engine turbine, the present invention efficiently extracts work from the pulse detonation combustor in the combustion stage of the engine. This Curtiss type stage can also be designed in a very robust manner capable of withstanding the pulsing flow exiting the combustor. This initial stage functions both to convert heat energy to mechanical energy and to smooth the flow pulsations. The more uniform flow exiting the Curtiss stage is now well suited to a Rateau stage or other types of modern turbine staging.

As used herein, a “pulse detonation combustor” PDC (also including PDEs) is understood to mean any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs (and PDEs) include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

### BRIEF DESCRIPTION OF THE DRAWINGS

The advantages, nature and various additional features of the invention will appear more fully upon consideration of the illustrative embodiment of the invention which is schematically set forth in the figures, in which:

FIG. 1 shows a diagrammatical representation of an embodiment of the present invention;

FIG. 2 shows a diagrammatical representation of another embodiment of the present invention;

FIG. 3 shows a graphical representation of pressure as a function of time for a pulse detonation device;

FIG. 4 shows a graphical representation of turbine stage efficiency for both Curtiss and Rateau stage turbines; and

FIG. 5 shows a graphical representation of turbine stage efficiency for impulse and reaction type turbines.

### DETAILED DESCRIPTION OF THE INVENTION

The present invention will be explained in further detail by making reference to the accompanying drawings, which do not limit the scope of the invention in any way.

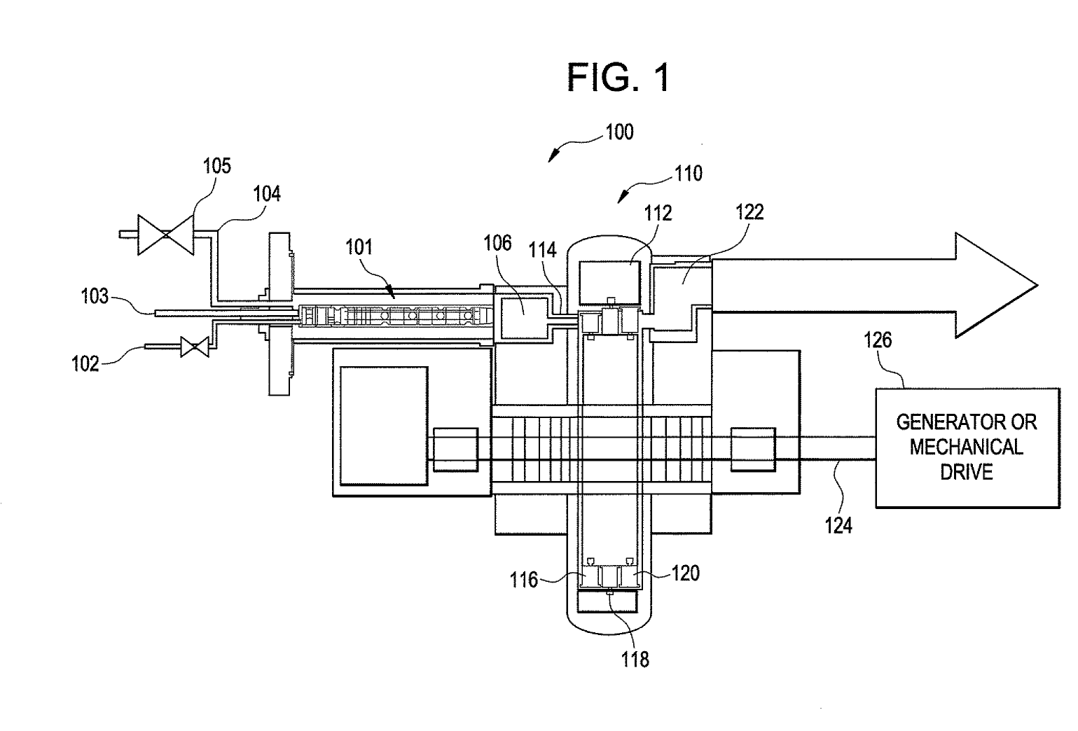

FIG. 1 depicts an engine 100 having a pulse detonation combustor 101 and a turbine 110 in accordance with an embodiment of the present invention. The turbine 110 has a Curtiss type turbine stage 112 and is positioned downstream of the combustor 101. The use of the Curtiss type turbine stage 112 allows for the efficient extraction of work energy from the pulse detonation combustor 101. Although not shown, the engine 100 contains, or is coupled to, and air/oxidizer source such as a compressor to provide air/oxidizer for the combustor 101. The present invention is not limited by the air/oxidizer source, as any known source can be used.

As discussed above, and is understood in the art, the output from a pulse detonation device or combustor is cyclic with significant variation in temperature, pressure and flow in time. As such, it has been difficult to efficiently extract work from such pulse detonation devices, in typical gas turbine configurations. An embodiment of the present invention accomplishes this by using a Curtiss type turbine stage 112 in a turbine 110, where the Curtiss type turbine portion is downstream of the pulse detonation combustion device 101. In another embodiment of the present invention the Curtiss type turbine stage 112 is positioned immediately downstream of the combustion device 101, with no other turbine stage in between the Curtiss stage 112 and the combustor 101.

Curtiss type turbine stages have been used to extract energy in steam turbine applications. A Curtiss type turbine stage 112 contains a nozzle portion 114 through which the exhaust from the combustor 101 passes. The nozzle portion 114 orients the flow in the proper direction for passage into a downstream rotor stage 116, discussed more fully below. In an embodiment of the present invention, the nozzle portion 114 is a converging-diverging nozzle, such that the velocity of the exhaust gas is increased while its pressure is decreased. However, in additional embodiments of the present invention, it is contemplated that the nozzle portion be either a converging or diverging nozzle. It is also contemplated that the nozzle portion 114 be a constant area nozzle.

Downstream of the nozzle portion 114 is a first rotor stage 116 which has a plurality of blades (not shown) which are rotated about an axis of the rotor stage 116. The first rotor stage 116 extracts work from the flow. Downstream of the first rotor stage 116 is a stator stage 118. The stator stage 118 contains a plurality of vanes which redirect the flow from the first rotor stage to a second rotor stage 120. The second rotor stage 120 is downstream of the stator stage 118. The second rotor stage 120 extracts additional work from the flow. The above construction constitutes what is known as a single Curtiss stage, which is a nozzle portion followed by a rotor, followed by a stator, followed by a rotor.

In this configuration, there is a pressure drop in the nozzle portion 114, but there are no further pressure drops in any of the rotor or stator stages. However, across both the first and second rotor stages 116, 120 there is a velocity drop, thus providing velocity compounding blading.

This Curtiss stage configuration allows for the efficient extraction of energy from the exhaust flow of the combustor 101. The use of the Curtiss type turbine stage 112 aids in smoothing out the temporal pressure and velocity variations which are typical in the operation of pulse detonation combustors. This permits the efficient extraction of work from the pulse detonation combustors.

In the exemplary embodiment shown in FIG. 1 downstream of the second rotor stage 120 is an exhaust plenum 122 which provides the exhaust gas to either an exhaust of the engine 100 or to additional turbine stages.

In the embodiment shown in FIG. 1 the first and second rotor stages 116, 120 are coupled to a shaft 124 which is rotated and provides the rotation to either a generator or mechanical drive device 126 of some kind. It is noted that the present invention is not limited to the applications or structure used to extract the work and energy from the turbine stage. It is contemplated that the present invention has land based applications, which include (but are not limited to) driving a compressor, generator, pump, fan, etc. and propulsion systems where one or more turbine stages is used to drive a compressor and/or generate thrust.

Additionally, the present invention is not limited to the configuration and exact geometry of the rotors and stator and/or the blades and vanes on the rotors and stator. These components are to be configured so as to optimize performance based on the design operational and performance parameters.

In an embodiment of the present invention, fuel for the combustor 101 is provided through a flow control device 102 and air flow is provided through a primary air flow 103 and/or a secondary air flow 104 which is controlled via a valve 105. It is noted that the present invention is not limited to the overall operation and construction of the combustor 101. It is understood that any commonly known and understood operation and construction of a pulse detonation combustor may be used in conjunction with the present invention.

In an embodiment of the present invention, a plurality of combustors 101 may be used, which may be operated in or out of phase with each other.

In an embodiment of the invention, the exhaust of the combustor 101 enters an inlet plenum 106, which is coupled to the nozzle portion 114 of the Curtiss turbine stage 110. The configuration and structure of the inlet plenum 106 is to provide maximum operational efficiency.

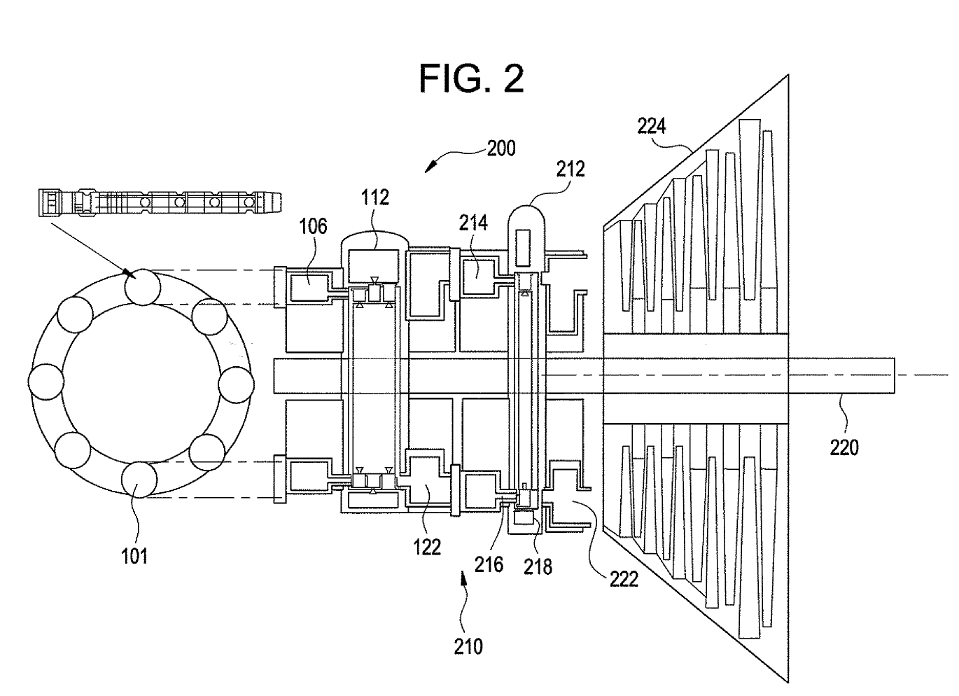

FIG. 2 depicts another embodiment of the present invention. FIG. 2 depicts an engine 200 having a plurality of pulse detonation combustors 101 distributed in a radial configuration. It is noted that for the purposes of clarity an end view of the combustors 101 is shown whereas the remaining portion of the figure is depicted in a cross-sectional view.

In this embodiment of the invention, there are eight combustors 101 distributed radially around a center point. However, the present invention is not limited to the number of combustors 101 or their respective distribution. The distribution geometry and number of combustors 101 are to be determined based on the operational and performance characteristics of the overall engine 200. Moreover, as with the engine 100 in FIG. 1, the present invention is not limited by the operation and construction of the combustors 101. Specifically, the combustors 101 may be operated and constructed in any known way.

In an embodiment of the invention, the combustors 101 are controlled such that they all detonate at the same time, and thus have a synchronized operation. In another embodiment of the invention, the combustors 101 are operated such that a number of the combustors 101 (for example half) are operated out of phase with the remaining number of combustors 101. In such an embodiment it is contemplated that while one combustor 101 is in a blow down phase, each of the adjacent combustors 101 are in a fill or purge stage. Further, in an additional embodiment, it is contemplated that the operation of each of the combustors is out of sequence which each other combustor, so as to provide an almost steady flow to the turbine stage.

In the embodiment shown in FIG. 2, each of the combustors 101 provide their respective exhaust into an individual inlet plenum 106 which directs the exhaust flow to a turbine 210. In the embodiment shown the portion of the turbine 210 immediately downstream of the combustors 101 is a Curtiss type turbine stage 112. Because the fundamental structure and configuration of the Curtiss type turbine stage 112 has been discussed with regard to FIG. 1, its discussion will not be repeated.

In an alternative exemplary embodiment of the invention, at least some of the combustors 101 (and in another embodiment, all of the combustors 101) provide their exhaust flow into a single exhaust plenum, in which the respective flows are at least partially mixed. Downstream of the common exhaust plenum (not shown) are the inlet nozzles for the Curtiss stage 112.

In the embodiment shown in FIG. 2, immediately downstream of the exhaust plenum 122 is a second inlet plenum 214 for a Rateau type turbine stage 212. In a single Rateau type turbine stage a nozzle diaphragm is positioned immediately upstream of a row of moving blades. As shown in FIG. 2, downstream of the second inlet plenum 214 is a second nozzle portion 216, which is the nozzle portion of a Rateau type turbine stage. Immediately following the nozzle portion 216 is a rotor stage 218. Like the rotor stages of the Curtiss type turbine stage 112, the rotor stage 218 is coupled to a shaft 220 so as to rotate the shaft 220. In a further exemplary embodiment, at least one of the other stages, for example the Rateau type turbine stage 212 is coupled to a second shaft (not shown), which is different than the shaft 220. In such an embodiment, it is contemplated that the second shaft rotates at a different speed than the shaft 220.

As with the Curtiss type turbine stage 112, the second nozzle portion 216 is to be configured to optimize flow and operation of the Rateau type turbine stage 212. In an embodiment of the invention, the nozzle construction is that of a converging-diverging nozzle so that velocity of the flow is increased while pressure is decreased. However, it is also contemplated that the nozzle be configured as a diverging or converging nozzle.

In an embodiment of the invention, as the flow exits the nozzle portion 216, the flow passes through the blades (not shown) of the rotor stage 218, where work is extracted from the flow (in the form of rotation of the shaft 220). As the work is extracted from the flow, the velocity of the flow will decrease even though the overall pressure of the flow will not be decreased. Further, because the velocity of the flow is increased in the nozzle portion 216 and subsequently dropped in the rotor stage 218, the velocity of the flow from the beginning of the Rateau stage 212 to the end remains unchanged. Because there is an overall pressure drop, while velocity is not dropped in any appreciable way, the Rateau staging is considered to be pressure compounding.

In the embodiment shown in FIG. 2, after the flow passes through the rotor stage 218, the flow enters a second exhaust plenum 222. Downstream of the second exhaust plenum 222 is a third turbine stage 224. In an embodiment of the invention, the third turbine stage 224 is a high efficiency turbine stage which is commonly known and understood as being used in typical gas turbine applications. Because the structure and operation of these turbine types are well known, a detailed discussion will not be incorporated herein.

It is contemplated that the third turbine stage 224 can be of a impulse turbine type or a reaction turbine type, or any combination thereof. Moreover, it is contemplated that the third turbine stage 224 not be limited to a single “stage” but can have any number and combination of rotors and stators such that the optimal operating efficiency and performance of the turbine and engine is achieved. It is noted that in an embodiment of this aspect of the invention, the turbine stage 224 blade speed can be near the flow velocity but does not exceed the flow velocity. In this embodiment, this provides improved operational performance and efficiency.

The embodiment depicted in FIG. 2 is an exemplary embodiment of the invention, where the combustion stage of the engine is followed by a single Curtiss stage, followed by a single Rateau stage, followed by a third turbine stage which is a high efficiency turbine stage of some kind. However, the present invention is not limited to this embodiment. For example, it is contemplated that the Curtiss 112 stage is followed by at least one additional Curtiss stage, which is then followed by a typical high efficiency turbine stage. An additional embodiment contains at least one Curtiss stage 212 followed by a plurality of Rateau stages 212, which may be followed by a third turbine stage which is a high efficiency turbine stage.

In another alternative embodiment, the initial Curtiss stage 112 is followed by at least one Rateau stage 212, which is followed by at least one other Curtiss stage 112. In yet a further embodiment, the Curtiss stage 112 is followed by a Rateau stage 212, and no additional downstream turbine stage is provided.

Thus, the present invention is not limited to the types and combinations of turbine stages located downstream of the at least one first Curtiss type turbine stage 112. The configuration, number and type of turbine stages downstream of the first Curtiss type turbine stage 112 are to be optimized for the desired operational parameters and performance

In one embodiment of the invention the various inlet and outlet plenums for each of the respective turbine stages are discrete individual plenum structures. However, in an alternative embodiment of the present invention the plenum structure is in a single annulus form. The respective shapes, sizes and volumes of the plenum structures are designed to optimize the uniformity of the flow between the various stages of the turbine.

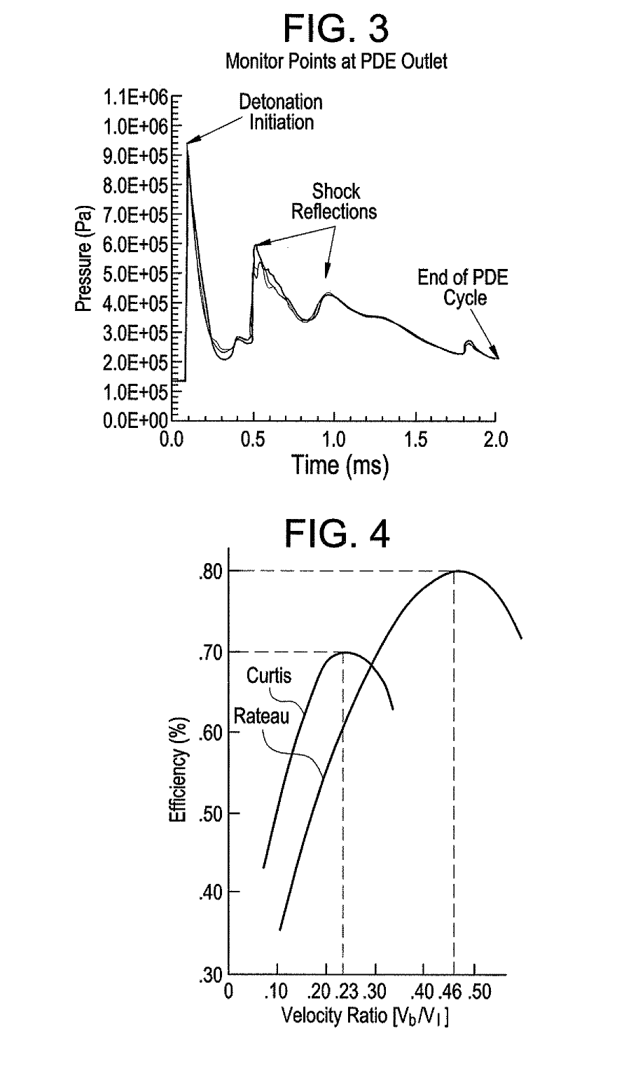

FIG. 3 depicts a graphical representation of pressure as a function of time for a pulse detonation device. As can be seen, pressure peaks at detonation initiation very early in the detonation cycle and drops significantly to the end of the pulse detonation cycle. Further, as shown, there is an additional pressure rise as shock reflections (from the detonation) propagate through the pulse detonation device. It is understood that FIG. 3 represents the operation of an exemplary pulse detonation device and does not limit the present invention in any way.

FIG. 4 is a graphical representation of turbine stage efficiency for both Curtiss type and Rateau type turbine stages. As can be seen the efficiency of Rateau stages is typically higher than that of Curtiss stages. However, in typical Rateau stages, this higher efficiency requires higher blade speeds (in the rotor portion of the turbine stage) which may not be optimal in the first stage of the turbine section of an engine, because of the rapid changes in flow velocity and pressure. It is common in aircraft engines and land-based gas turbines to employ multiple shafts. In this manner, the turbine can be separated into high and low pressure stages where each can be operated at their optimal speed.

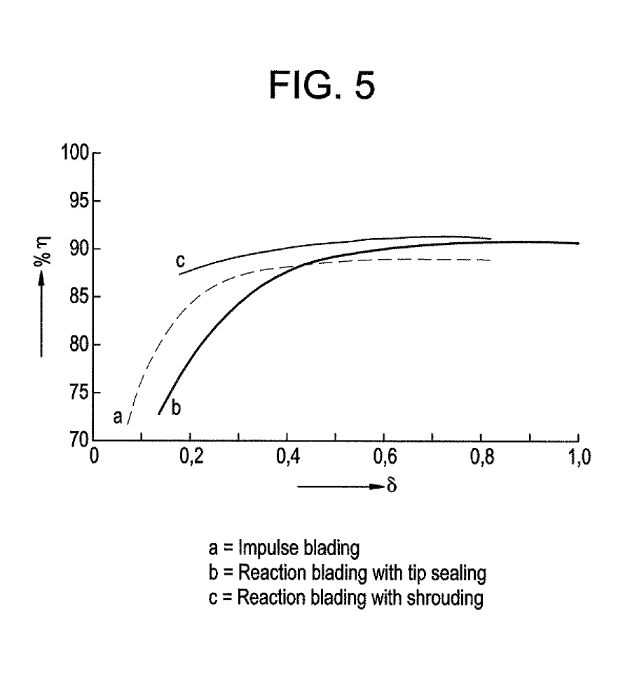

FIG. 5 is a graphical representation of turbine stage efficiency for impulse and reaction type turbines, where

$$δ = \frac{volumetric flow through the turbine}{{( turbine radius )}^{2} \times blade velocity}$$

The graph depicts the efficiency of impulse blading (a) and two versions of reaction blading (b and c). Because the overall configuration and structure of these turbine types are known in the art, there detailed discussion will not be incorporated herein. However, it is noted that the present invention contemplates using any one, all, or any combination thereof, of these turbine types downstream of the Curtiss type turbine stage 112.

It is noted that although the present invention has been discussed above specifically with respect to aircraft applications, the present invention is not limited to this and can be in any similar detonation/deflagration device in which the benefits of the present invention are desirable. The present invention can be used in any engine type device used to generate work through the use of turbines. For example, including but not limited to, aircraft engines, power generators, compressors and the like.

While the invention has been described in terms of various specific embodiments, those skilled in the art will recognize that the invention can be practiced with modification within the spirit and scope of the claims.

What is claimed is:

1. An engine, comprising:
a combustion portion comprising at least one pulse detonation combustor; and
a turbine portion downstream of said combustion portion,
wherein said turbine portion contains at least one Curtiss type turbine stage positioned downstream of said combustion portion to receive exhaust flow from said pulse detonation combustor.

2. The engine of claim 1, wherein said at least one Curtiss type turbine stage is a first stage of said turbine portion.

3. The engine of claim 1, wherein said turbine portion further comprises at least one of a second Curtiss type turbine stage, Rateau type turbine stage, impulse turbine stage and reaction type turbine stage, or combination thereof positioned downstream of and communicated with said at least one Curtiss type turbine stage.

4. The engine of claim 1, wherein said at least one Curtiss type turbine stage is coupled to at least one inlet plenum and at least one exhaust plenum.

5. The engine of claim 1, wherein said at least one Curtiss type turbine stage comprises a first and second rotor stage, and each of said first and second rotor stages are coupled to a shaft.

6. The engine of claim 5, further comprising at least one Rateau type turbine stage positioned downstream of and communicated with said at least one Curtiss type turbine stage and wherein said at least one Rateau type turbine stage contains a third rotor stage coupled to said shaft.

7. The engine of claim 5, further comprising at least one of either an impulse type turbine stage and reaction type turbine stage positioned downstream of and communicated with said at least one Curtiss type turbine stage and wherein said at least one impulse type turbine stage or reaction type turbine stage comprises at least one additional rotor stage coupled to said shaft.

8. The engine of claim 1, further comprising a Rateau type turbine stage communicated with and positioned downstream of said at least one Curtiss type turbine stage and a third turbine stage communicated with and positioned downstream of said Rateau type turbine stage.

9. The engine of claim 8, wherein said third turbine stage is at least one of an impulse type turbine stage, at least one of a reaction type turbine stage, or a combination thereof.

10. The engine of claim 1, wherein said turbine portion further comprises at least one of a second Curtiss type turbine stage, Rateau type turbine stage, impulse turbine stage and reaction type turbine stage, positioned downstream of and communicated with said at least one Curtiss type turbine stage, and coupled to a second shaft.

11. The engine of claim 10, wherein said second shaft is rotated a speed different from said first shaft.

12. The engine of claim 1, having a plurality of said pulse detonation combustors, wherein said at least some of said combustors are operated out of phase with each other.

13. An engine, comprising:
a combustion portion comprising at least one pulse detonation combustor; and
a turbine portion downstream of said combustion portion,
wherein said turbine portion contains at least one Curtiss type turbine stage positioned downstream of said combustion portion to receive exhaust flow from said pulse detonation combustor, and wherein said at least one Curtiss type turbine stage is a first stage of said turbine portion.

14. The engine of claim 13, wherein said turbine portion further comprises at least one of a second Curtiss type turbine stage, Rateau type turbine stage, impulse turbine stage and reaction type turbine stage, or combination thereof, positioned downstream of and communicated with said at least one Curtiss type turbine stage.

15. The engine of claim 13, wherein said at least one Curtiss type turbine stage comprises a first and second rotor stage, and each of said first and second rotor stages are coupled to a shaft.

16. The engine of claim 15, further comprising at least one Rateau type turbine stage positioned downstream of and communicated with said at least one Curtiss type turbine stage and wherein said at least one Rateau type turbine stage is coupled to said shaft.

17. The engine of claim 15, further comprising at least one Rateau type turbine stage positioned downstream of and communicated with said at least one Curtiss type turbine stage and wherein said at least one Rateau type turbine stage is coupled to a second shaft.

18. An engine, comprising:
at least one a pulse detonation combustor;
at least one turbine stage located downstream of said at least one pulse detonation combustor to receive an exhaust of said at least one pulse detonation combustor,
wherein said at least one turbine stage comprises:
a nozzle portion,
a rotor portion downstream of said nozzle portion,
a stator portion downstream of said rotor portion, and
a second rotor portion downstream of said stator portion,
wherein said nozzle portion directs said exhaust downstream to said rotor portion; and
a second turbine stage communicated with said at least one turbine stage and located downstream of said at least one turbine stage, wherein said second turbine stage comprises:
a nozzle portion, and
a rotor portion downstream of said nozzle portion,
wherein said nozzle portion directs said exhaust downstream to said rotor portion.

19. The engine of claim 18, wherein said at least one turbine stage is located immediately downstream of said at least one pulse detonation combustor such that said exhaust from said combustor does not pass through any other turbine stage before said at least one turbine stage.
